(19) United States
(12) Patent Application Publication
(10) Pub. No.: US 2021/0271645 A1
(43) Pub. Date: Sep. 2, 2021

(54) Log-Based Storage Space Management for Geographically Diverse Storage

(71) Applicant: EMC IP Holding Company LLC, Hopkinton, MA (US)

(72) Inventors: Mikhail Danilov, Saint Petersburg (RU); Yohannes Altaye, Dumfries, VA (US)

(21) Appl. No.: 16/803,913

(22) Filed: Feb. 27, 2020

(51) Int. Cl. G06F 16/174; G06F 16/17; G06F 16/16; G06F 16/182

(52) U.S. Cl. CPC G06F 16/1752; G06F 16/182; G06F 16/162; G06F 16/1734

(57) ABSTRACT

Log-based storage space management related to data convolution in a geographically diverse data storage system is disclosed. Data chunks stored in storage devices of different zones of a zone storage system can be convolved to conserve computing resources. Deletion of a chunk from a first zone can be coupled to generating another chunk in another zone to preserve the integrity of a redundant data protection scheme. In response to determining that a first chunk is to be deleted, a log can be generated that can indicate the first chunk is available to be deleted and can indicate other affected chunks. In an aspect, the other affected chunks can comprise a convolved chunk that can convolve the first chunk and at least a second chunk. Accordingly a third chunk can be generated to facilitate deletion of the first chunk while preserving protection of information in the second chunk. Generation of the third chunk can be deferred until a threshold condition is determined to be satisfied.

### TECHNICAL FIELD

The disclosed subject matter relates to data convolution, more particularly, to log-based management of storage space among geographically diverse storage devices.

### BACKGROUND

Conventional data storage techniques can employ convolution and deconvolution of data to conserve storage space. As an example, convolution can allow data to be packed or hashed in a manner that uses less space that the original data. Moreover, convolved data, e.g., a convolution of first data and second data, etc., can typically be de-convolved to the original first data and second data. One use of data storage is in bulk data storage.

### BRIEF DESCRIPTION OF DRAWINGS

FIG. 1 is an illustration of an example system that can facilitate log-based management of storage space for geographically diverse storage, in accordance with aspects of the subject disclosure.

FIG. 2 is an illustration of an example system that can facilitate reducing convolution of a convolved chunk in accord with log-based management of storage space for geographically diverse storage, in accordance with aspects of the subject disclosure.

FIG. 3 is an illustration of an example system that can enable deferred reduction of convolution of a convolved chunk in accord with log-based management of storage space for geographically diverse storage, in accordance with aspects of the subject disclosure.

FIG. 4 illustrates an example system that can facilitate log-based management of storage space for geographically diverse storage employing distributed deleting component(s), in accordance with aspects of the subject disclosure.

FIG. 5 is an illustration of example system states for log-based management of storage space for geographically diverse storage, wherein the log-based management comprises replication of a portion of information comprised in a convolved chunk, in accordance with aspects of the subject disclosure.

FIG. 6 is an illustration of example system states for log-based management of storage space for geographically diverse storage, wherein the log-based management avoids replication of a portion of information comprised in a convolved chunk, in accordance with aspects of the subject disclosure.

FIG. 7 is an illustration of an example method facilitating log-based management of storage space for geographically diverse storage, in accordance with aspects of the subject disclosure.

FIG. 8 illustrates an example method that enables log-based management of storage space for geographically diverse storage, wherein the log-based management comprises reducing a convolved chunk or generating a new chunk to provide data protection, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As mentioned, data storage techniques can employ convolution and deconvolution to conserve storage space. As an example, convolution can allow data to be packed or hashed in a manner that uses less space that the original data. Moreover, convolved data, e.g., a convolution of first data and second data, etc., can typically be de-convolved to the original first data and second data. One use of data storage is in bulk data storage. Examples of bulk data storage can include networked storage, e.g., cloud storage, for example ECS, formerly ‘ELASTIC CLOUD STORAGE,’ offered by Dell EMC. Bulk storage can, in an aspect, manage disk capacity via partitioning of disk space into blocks of fixed size, frequently referred to as chunks, for example a 128 MB chunk, etc. Chunks can be used to store user data, and the chunks can be shared among the same or different users, for example, one chunk may contain fragments of several user objects. A chunk's content can generally be modified in an append-only mode to prevent overwriting of data already added to the chunk. As such, when a typical chunk becomes full enough, it can be sealed so that the data therein is generally not able for further modification. These chunks can be then stored in a geographically diverse manner, typically chunks are stored in locations that are distant from each other, e.g., different cities, states, countries, etc., to allow for recovery of the data where a first copy of the data is destroyed, e.g., disaster recovery, etc. Blocks of data, hereinafter ‘data chunks’, or simply ‘chunks’, can be used to store user data. Chunks can be shared among the same or different users, e.g., a typical chunk can contain fragments of different user data objects. Chunk contents can be modified, for example, in an append-only mode to prevent overwriting of data already added to the chunk, etc. As such, for a typical append-only chunk that is determined to be full, the data therein is generally not able to be further modified. Eventually the chunk can be stored ‘off-site’, e.g., in a geographically diverse manner, to provide for disaster recovery, etc. Chunks from a data storage device, e.g., ‘zone storage component’, ‘zone storage device’, etc., located in a first geographic location, hereinafter a ‘zone’, etc., can be stored in a second zone storage device that is located at a second geographic location different from the first geographic location. This can enable recovery of data where the first zone storage device is damaged, destroyed, offline, etc., e.g., disaster recovery of data, by accessing the off-site data from the second zone storage device.

Geographically diverse data storage can use data compression, e.g., a form of convolution, to store data. As an example, a storage device in Topeka can store a backup of data from a first zone storage device in Houston, e.g., Topeka can be considered geographically diverse from Houston. As a second example, data chunks from Seattle and San Jose can be stored in Denver. The example Denver storage can be compressed or uncompressed, wherein uncompressed indicates that the Seattle and San Jose chunks are replicated in Denver, and wherein compressed indicates that the Seattle and San Jose chunks are convolved, for example via an ‘XOR’ operation, into a different chunk to allow recovery of the Seattle or San Jose data from the convolved chunk, but where the convolved chunk typically consumes less storage space than the sum of the storage space for both the Seattle and San Jose chunks individually. In an aspect, compression can comprise convolving data and decompression can comprise deconvolving data, hereinafter the terms compress, compression, convolve, convolving, etc., can be employed interchangeably unless explicitly or implicitly contraindicated, and similarly, decompress, decompression, deconvolve, deconvolving, etc., can be used interchangeably. Compression, therefore, can allow original data to be recovered from a compressed chunk that consumes less storage space than storage of the uncompressed data chunks. This can be beneficial in that data from a location can be backed up by redundant data in another location via a compressed chunk, wherein a redundant data chunk can be smaller than the sum of the data chunks contributing to the compressed chunk. As such, local chunks, e.g., chunks from different zone storage devices, can be compressed via a convolution technique to reduce the amount of storage space used by a compressed chunk at a geographically distinct location, e.g., a 128 KB convolved chunk can comprise information represented in two or more 128 KB other chunks, wherein the other chunks can be convolved or unconvolved chunks. As an example, a first 128 KB unconvolved Seattle chunk can be convolved with a second 128 KB unconvolved Denver chunk in a third 128 KB convolved Dallas chunk. As another example, a first 128 KB unconvolved Seattle chunk can be convolved with a second 128 KB convolved Boston chunk in a third 128 KB convolved Dallas chunk, wherein the second Boston chunk can itself convolve other convolved or unconvolved chunks.

In an embodiment, a convolved chunk stored at a geographically diverse storage device can comprise data from all storage devices of a geographically diverse storage system. As an example, where there are five storage devices, a first storage device can convolve chunks from the other four storage devices to create a ‘backup’ of the data from the other four storage devices. In this example, the first storage device can create a backup chunk from chunks received from the other four storage devices. In an aspect, this can result in generating copies of the four received chunks at the first storage device and then convolving the four chunks to generate a fifth chunk that is a backup of the other four chunks. Moreover, one or more other copies of the four chunks can be created at the first storage device for redundancy, for example if each chunk has two redundant chunks created, then the four received chunks and their redundant copies results in creating 12 chunks at the first storage device before creating the convolved chunk that is then also redundantly copied resulting in 15 chunk creation events. Further, the 12 redundant copies of the four received chunks can then be deleted, e.g., the storage space is released for reuse, the corresponding storage space is overwritten and released, etc., leaving just the convolved chunk and related redundant copy(ies) thereof. Similarly, deconvolving chunks can comprise replication of chunks between zones to enable a deconvolution operation. These aspects can result in high counts of disk read/write events, network traffic within the zone, e.g., where a storage device comprises networked disks, etc., corresponding heat and energy usage, etc. As such, it can be desirable to reduce the use of redundant copies in creation/modification of convolved chunks.

In an embodiment of the disclosed subject matter, a first data chunk and a second data chunk corresponding to a first and second zone that are geographically diverse can be stored in a third data chunk stored at third zone that is geographically diverse from the first and second zones. In an aspect the third chunk can represent the data of the first and second data chunks in a compressed form, e.g., the data of the first data chunk and the second data chunk can be convolved, such as by an XOR function, into the third data chunk. In an aspect, first data of the first data chunk and second data of the second data chunk can be convolved with or without replicating the entire first data chunk and the entire second data chunk at data store(s) of the third zone, e.g., as at least a portion of the first data chunk and at least a portion of the second data chunk are received at the third zone, they can be convolved to form at least a portion of the third data chunk. Where compression occurs without replicating a chunk at another zone prior to compression, this can be termed as ‘on-arrival data compression’ and can reduce the count of replicate data made at the third zone and data transfers events can correspondingly also be reduced. As an example, chunk 112 and chunk 122 can be on-arrival convolved into chunk 132, e.g., without forming chunk 113 and chunk 123. In some embodiments, replicates of the third data chunk can be stored in the data store(s) of the third zone. As an example, chunk 232 can be replicated in third zone storage component (ZSC) 230 as chunk 234, chunk 236, etc. In an aspect, a ZSC can comprise one or more data storage components that can be communicatively coupled, e.g., a ZSC can comprise one data store, two or more communicatively coupled data stores, etc., such that the replication of data in the ZSC can provide data redundancy in the ZSC, for example, providing protection against loss of one or more data stores of the ZSC. As an example, a ZSC can comprise multiple hard drives and data replicates can be stored on more than one hard drive such that, if a hard drive fails, other hard drives of the ZSC can access a data replicate. Similarly, deconvolving a convolved chunk can also be performed ‘on-arrival’ of replicated data employed in the deconvolution.

Compression of chunks can be performed by different compression technologies. Logical operations can be applied to chunk data to allow compressed data to be recoverable, e.g., by reversing the logical operations to revert to the initial chunk data. As an example, data from chunk A can undergo an exclusive-or operation, hereinafter ‘XOR’, with data from chunk B to form chunk C. While other logical and/or mathematical operations can be employed in compression of chunks, those operations are generally beyond the scope of the presently disclosed subject matter and, for clarity and brevity, only the XOR operator will be illustrated herein. However, it is noted that the disclosure is not so limited and that those other operations or combinations of operations can be substituted without departing from the scope of the present disclosure. As such, all logical and/or mathematical operations for compression germane to the disclosed subject matter are to be considered within the scope of the present disclosure even where not explicitly recited for the sake of clarity and brevity.

In an aspect, the presently disclosed subject matter can include ‘zones’. A zone can correspond to a geographic location or region. As such, different zones can be associated with different geographic locations or regions. As an example, Zone A can comprise Seattle, Wash., Zone B can comprise Dallas, Tex., and, Zone C can comprise Boston, Mass. In this example, where a local chunk from Zone A is replicated, e.g., compressed or uncompressed, in Zone C, an earthquake in Seattle can be less likely to damage the replicated data in Boston. Moreover, a local chunk from Dallas can be convolved with the local Seattle chunk, which can result in a compressed/convolved chunk, e.g., a partial or complete chunk, which can be stored in Boston. As such, either the local chunk from Seattle or Dallas can be used to de-convolve the partial/complete chunk stored in Boston to recover the full set of both the Seattle and Dallas local data chunks. The convolved Boston chunk can consume less disk space than the sum of the Seattle and Dallas local chunks. An example technique can be “exclusive or” convolution, hereinafter ‘XOR’, ‘⊕’, etc., where the data in the Seattle and Dallas local chunks can be convolved by XOR processes to form the Boston chunk, e.g., C=A1 ⊕B1, where A1 is a replica of the Seattle local chunk, B1 is a replica of the Dallas local chunk, and C is the convolution of A1 and B1. Of further note, the disclosed subject matter can further be employed in more or fewer zones, in zones that are the same or different than other zones, in zones that are more or less geographically diverse, etc. As an example, the disclosed subject matter can be applied to data of a single disk, memory, drive, data storage device, etc., without departing from the scope of the disclosure, e.g., the zones represent different logical areas of the single disk, memory, drive, data storage device, etc. Moreover, it will be noted that convolved chunks can be further convolved with other data, e.g., D=C1 ⊕E1, etc., where E1 is a replica of, for example, a Miami local chunk, E, C1 is a replica of the Boston partial chunk, C, from the previous example and D is an XOR of C1 and E1 located, for example, in Fargo.

In an aspect, XORs of data chunks in disparate geographic locations can provide for de-convolution of the XOR data chunk to regenerate the input data chunk data. Continuing a previous example, the Fargo chunk, D, can be de-convolved into C1 and E1 based on either C1 or D1; the Miami chunk, C, can be de-convolved into A1 or B1 based on either A1 or B1; etc. Where convolving data into C or D comprises deletion of the replicas that were convolved, e.g., A1 and B1, or C1 and E1, respectively, to avoid storing both the input replicas and the convolved chunk, de-convolution can rely on retransmitting a replica chunk that so that it can be employed in de-convoluting the convolved chunk. As an example the Seattle chunk and Dallas chunk can be replicated in the Boston zone, e.g., as A1 and B1. The replicas, A1 and B1 can then be convolved into C. Replicas A1 and B1 can then be deleted because their information is redundantly embodied in C, albeit convolved, e.g., via an XOR process, etc. This leaves only chunk C at Boston as the backup to Seattle and Dallas. If either Seattle or Dallas is to be recovered, the corollary input data chunk can be used to de-convolve C. As an example, where the Seattle chunk, A, is corrupted, the data can be recovered from C by de-convolving C with a replica of the Dallas chunk B. As such, B can be replicated by copying B from Dallas to Boston as B1, then de-convolving C with B1 to recover A1, which can then be copied back to Seattle to replace corrupted chunk A.

In an embodiment of the disclosed subject matter, a first data chunk and a second data chunk corresponding to a first and second zone that are geographically diverse can be stored in a third data chunk stored at third zone that is geographically diverse from the first and second zones. In an aspect the third chunk can represent the data of the first and second data chunks in a compressed form, e.g., the data of the first data chunk and the second data chunk can be convolved, such as by an XOR function, into the third data chunk. In an aspect, this provides the first data in the first data chunk at the first zone and information that represents the first data chunk in a convolved chunk of the third zone, e.g., convolved with the second data chunk. As such, if the first data chunk becomes less accessible, the data of the first data chunk can be recovered by deconvolving the convolved chunk with a representation of the second data chunk to recover a representation of the first data chunk, e.g., A XOR B=C and C XOR B=Recovered A, such that if A is less accessible, C XOR B can be employed to access the data via Recovered A.

In an aspect, where it is desirable to delete A, and A is represented in convolved chunk C, e.g., A XOR B=C, etc., then it can also be desirable to remove A information from C. While it may at first appear that if A is to be deleted, then A should just be deleted without addressing C, however, if A is deleted without addressing C, then the replicate information for B can become difficult to access. As an example, where A XOR B=C, and A is simply deleted without addressing C, then C remains convolved and access to information representative of B from chunk C can fail where a copy of A is no longer available to deconvolve C into recovered B, e.g., typically C XOR A=recovered B but A is no longer available. Accordingly, where A is to be deleted, a copy of A is first used to deconvolve C, e.g., C XOR A=recovered B, and then C, A, and the copy of A can be deleted to leave B and Recovered B. This is a general logic and is applicable where a convolved chunk can convolve numerous other chunks. In the above example, C merely comprises information from two other chunks, e.g., A and B, and, as such, another avenue becomes apparent. This other avenue can be to simply replicate B anew and then delete both A and C, for example, A XOR B=C, to delete A, copy B then delete A and C. In this example, there is still a replication of a chunk but the deconvolution operation can be avoided.

Extending the above example, where A XOR B XOR C XOR D XOR E XOR F XOR G=H, then deletion of A can involve 1) replicating A and deconvolving H into Z to remove the representation of A before deleting A, the copy of A, and H, thereby leaving B through G and Z that convolves B to G, or 2) replicating B through G then deleting A and H leaving B to G and the replicates of B to G, which replicates can then be convolved into Y. As such, it can be appreciated that promptly addressing a chunk delete operation can comprise consumption of computing resources, e.g., network resources, processor resources, storage resources, etc. In an aspect, the prompt addressing of deletion operations can preserve the integrity of replicate information comprised in a backup chunk, e.g., a convolved chunk. Whereas reducing the consumption of computing resources can be desirable, the presently disclosed subject matter can defer a deletion operation(s) to conserve computing resources.

In an embodiment, for example, where A XOR B XOR C XOR D XOR E XOR F XOR G=H, deletion of A can defer actual deletion and A can be ‘marked for deletion’, e.g., via a log, table, other data structure, in chunk A itself, etc. Where A is not yet deleted, the system can remain stable. As is noted herein above, for A to actually be deleted, the representation of A in convolved H should be addressed. Accordingly, H can be ‘marked as comprising a chunk to be deleted’. At some time, e.g., after a deferral period, upon other conditions indicating that A should be promptly deleted, etc., A can be extracted from H, e.g., resulting in generation of Z or Y as above, and A can then be actually deleted. As an example, A can be marked for deletion and H can be correspondingly marked, which condition can continue until the zone storing A begins to run low on storage space, e.g., increasing the pressure to recover the space used by A, wherein the low storage space condition can be used to trigger removing A from H and then deleting the corresponding extraneous chunks. In another example, after a selected time, for example an hour, a day, a week, etc., the expiration of a deferral period can trigger removing A from H and then deleting the corresponding extraneous chunks. As a further example, where a zone housing H has underutilized computing resources, the zone can trigger removing A from H and then deleting the corresponding extraneous chunks, e.g., the deletion operations(s) can be deferred until a point where the system is below a computing resource burden threshold, such as deferring the deletion operation(s) until late at night rather than performing them promptly during a busy part of the work day, etc.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

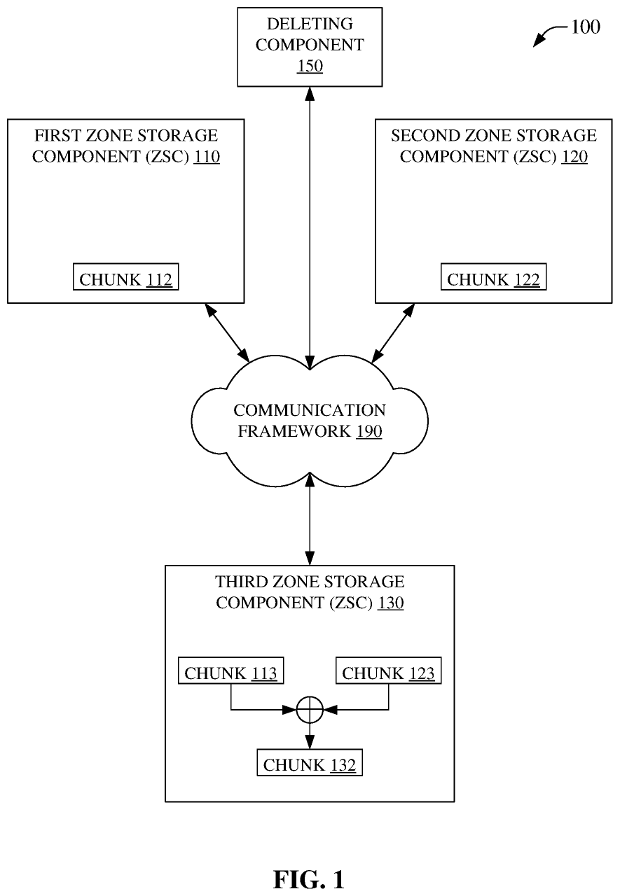

FIG. 1 is an illustration of a system 100, which can facilitate log-based management of storage space for geographically diverse storage, in accordance with aspects of the subject disclosure. System 100 can comprise three or more geographically diverse zones each comprising zone storage components (ZSCs), e.g., first ZSC 110, second ZSC 120, third ZSC 130, etc. The ZSCs can communicate with the other ZSCs of system 100, e.g., via communication framework 190, etc. A zone can correspond to a geographic location or region. As such, different zones can be associated with different geographic locations or regions. A ZSC can comprise one or more data stores in one or more locations. In an aspect, a ZSC can store at least part of a data chunk on at least part of one data storage device, e.g., hard drive, flash memory, optical disk, cloud storage, etc. Moreover, a ZSC can store at least part of one or more data chunks on one or more data storage devices, e.g., on one or more hard disks, across one or more hard disks, etc. As an example, a ZSC can comprise one or more data storage devices in one or more data storage centers corresponding to a zone, such as a first hard drive in a first location proximate to Miami, a second hard drive also proximate to Miami, a third hard drive proximate to Orlando, etc., where the related portions of the first, second, and third hard drives correspond to, for example, a ‘Miami zone’.

A geographically diverse storage system, e.g., a system comprising system 100, can create a replicate of a first chunk, e.g., chunk 112, at a geographically diverse ZSC, for example, chunk 113 at third ZSC 130, etc. The replicate at the geographically diverse ZSC can provide data redundancy. As an example, where first ZSC 110 is affiliated with a Seattle zone, and third ZSC 130 is affiliated with a Boston zone, then a regional event that compromises chunk 112 in the Seattle zone can be less likely to also compromise chunk 113 in the Boston zone. Similarly, chunk 122 can be replicated as chunk 123 to provide data redundancy for ZSC 120.

In an aspect, replication of chunks between different zones of system 100 can consume data storage resources, e.g., network traffic, data storage space, processor time, energy, manpower, etc. As an example, replication of chunk 112 and chunk 122 at third ZSC 130, e.g., as chunk 113 and chunk 123 respectively, can consume processing cycles at each of the first to third ZSCs 110, 120, and 130, can consume network resources to communicate the data between the first to third ZSCs 110, 120, and 130, can consume data storage space/resources at each of the first to third ZSCs 110, 120, and 130, etc. Moreover, where, as illustrated, a ZSC, e.g., ZSC 130, stores replicates of chunks from other zones, e.g., ZSCs 110 and 120, the replicated chunks, e.g., chunk 113 and chunk 123, can occupy a first amount of storage space, e.g., chunks 113 and 123 consume a first amount of storage space on storage device(s) of third ZSC 130. Compression of the redundant data can reduce the amount of consumed storage space while preserving the redundancy of the data. As an example, chunk 113 and chunk 123 can be compressed into chunk 132 that can consume less data storage space than the space associated with separately storing each of chunk 113 and chunk 123. In an embodiment, compression can be via an XOR operation of chunk 113 and chunk 123, e.g., ‘chunk 132=chunk 113 XOR chunk 123,’ etc. Thereafter, in some embodiments, chunks 113 and 123 can be deleted, e.g., the space used by chunks 113 and 123 can be freed, released, reclaimed, etc., for other uses.

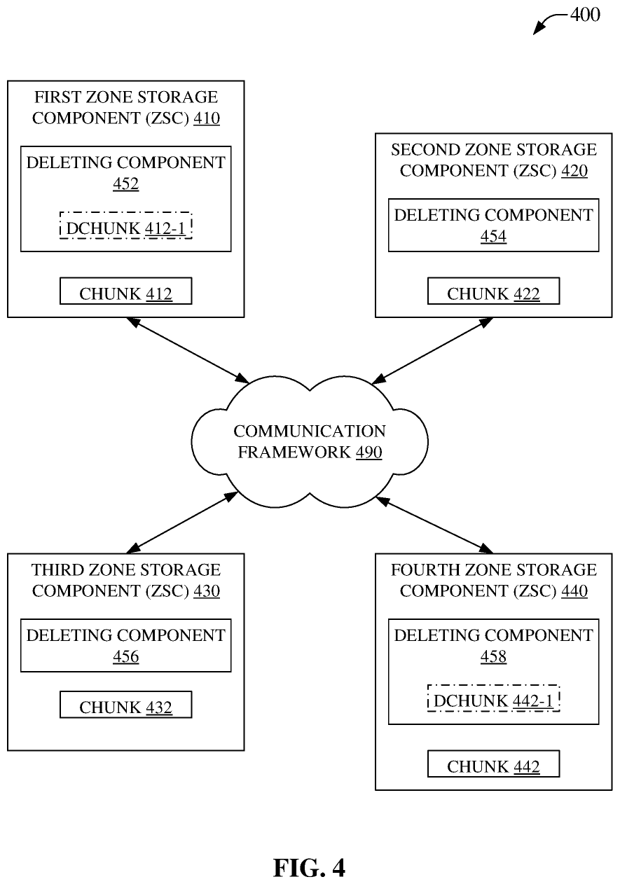

System 100 can further comprise deleting component 150. Deleting component 150 can log, track, monitor, etc., operations related to chunks of system 100. In an embodiment, deleting component 150 can be located separate from the ZSCs, e.g., as centralized component of system 100. In another embodiment, deleting component 150 can be comprised in a ZSC, distributed among the ZSCs, as instances in one or more ZSCs, etc., not illustrated in FIG. 1 but see FIG. 4, etc. Moreover, deleting component 150 can be embodied in a centralized component of system 100 functioning in conjunction with one or more instances of deleting component 150 local to a zone, e.g., a central deleting component 150 and one or more instances of deleting component 150 at one or more ZSCs of system 100, etc. As is disclosed herein above, a log of to be deleted chunk(s) and modification of convolved chunks comprising information represented by a to be deleted chunk can be employed to defer deletion operations in accord with the disclosed log-based management of storage space of a geographically diverse data storage system. As an example, where A XOR B XOR C XOR D XOR E XOR F XOR G=H, deletion of A can be associated with logging A and H by deleting component 150. In this example, deleting component 150 can further log a trigger condition to begin deletion operation(s), timing condition(s), resource condition(s), etc. Accordingly, deleting component 150 can facilitate log-based management of system 100, for example, by facilitating deferral of deletion of A and correspondingly updating H, etc.

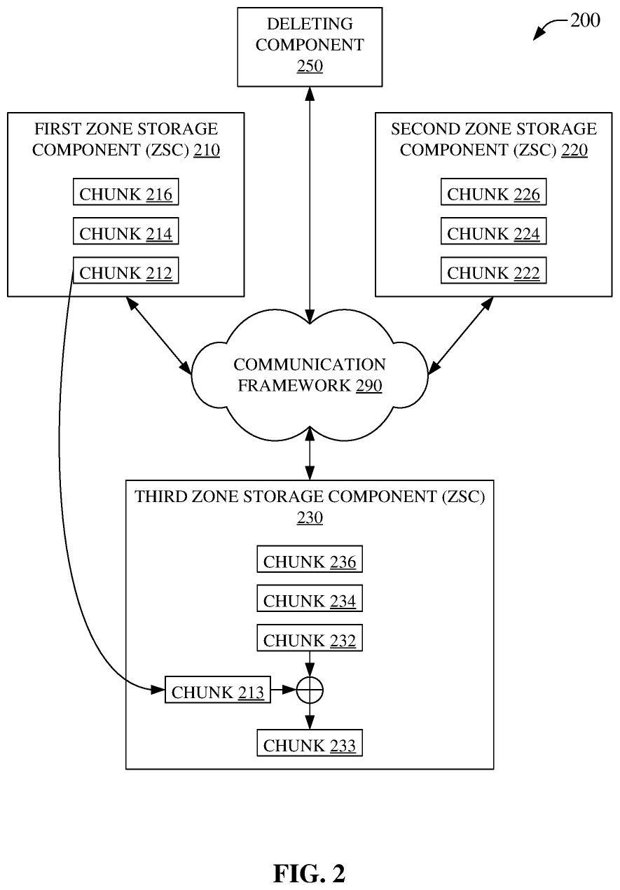

FIG. 2 is an illustration of a system 200, which can enable reducing convolution of a convolved chunk in accord with log-based management of storage space for geographically diverse storage, in accordance with aspects of the subject disclosure. System 200 can comprise ZSCs, e.g., ZSC 210-230, that can communicate via communication framework 290. System 200 can further comprise deleting component 250 that can coordinate deletion of chunks in a manner that comports with the presently disclosed subject matter, e.g., facilitating logging of to be deleted chunks, corresponding marking of convolved chunks, etc. First ZSC 210 can comprise various convolved and/or unconvolved chunks, e.g., chunks 212-216, etc. Similarly, second ZSC 220 can comprise chunks 222-226, etc., and third ZSC 230 can comprise chunks 232-236, etc. In an embodiment, chunk 232 can convolve information represented in chunks 212, 222, etc., e.g., copies of chunks 212, 222, etc., can previously have been copied to third ZSC 230 and been convolved to form chunk 232, the replicates of 212, 22, etc., thereafter being deleted and leaving chunk 232 as a backup of chunks 212, 222, etc., stored at other ZSCs of system 200.

In an aspect, system 200 can support deletion of chunks. Deletion of a chunk can be associated with modification of a corresponding replicate in another zone, e.g., modifying a convolved chunk of another zone where that convolved chunk comprises information representative of information in the chunk to be deleted. As an example, to delete chunk 212 from first ZSC 210, chunks 232 can be modified as well so as to facilitate access to other data stored therein. In an embodiment, chunk 212 of first ZSC 210 can be replicated at third ZSC 230 as chunk 213, where chunk 232 of third ZSC 230 convolves data representative of chunk 212. Chunk 213 can then be employed to reduce the convolution of chunk 232, e.g., Chunk 232 XOR chunk 212=chunk 233 wherein chunk 233 no longer comprises information representative of the information stored in chunk 212. This can result in third ZSC 230 comprising chunk 232, 213, and 233 and first ZSC 210 comprising chunk 212. At this point, chunks 232, 213, and 212 can be deleted without compromising the integrity of the redundancy of other chunks convolved in chunk 233. In an aspect, where chunk 232 was a convolution of only chunk 212 and 222, then reducing the convolution results in chunk 233 being an unconvolved replicate of chunk 222. However, where chunk 232 convolved chunks in addition to chunk 212 and 222, then chunk 233 would remain a convolution of all those chunks other than chunk 212, e.g., where chunk 232 is a convolution of chunk 212, 214, 222, and 224, then chunk 233 would be a convolution of chunks 214, 222, and 224. This can be appreciated by 212⊕214⊕222⊕224=232, then 232⊕213=(214⊕222⊕224) where 213 is a replicate of 212.

In an aspect, the deletion of chunk 212 can be undertaken promptly or can deferral of the deletion of 212 can be supported by system 200. In an aspect, deleting component 250 can record that chunk 212 is to be deleted and can signal third ZSC 230 accordingly. Deleting component can correspondingly record that chunk 232 is to be reduced by deconvolving data represented in chunk 212 from chunk 232. Where deleting is to be prompt, deleting component 250 can signal first ZSC 210 to cause a replicate, e.g., chunk 213, to be generated at third ZSC 230 and chunk 232 can be deconvolved into chunk 233. At this point, deleting component 250 can signal first ZSC 210 to delete chunk 212 and can signal third ZSC 230 to delete chunks 232 and 213. In an aspect, the ZSCs can delete these chunks at any time as they are no longer relevant to storage of data or storage of redundant data, e.g., they are garbage chunks upon formation of chunk 233. In an aspect, deleting chunks 212, 232, and 213 after reduction of chunk 232 can free the space for other uses, e.g., to be overwritten by other data, etc., can cause actual overwriting to obliterate data stored at these chunks, or nearly any other means of ‘deleting’ stored data that is germane to the presently disclosed subject matter. Where the deleting is to be deferred, deleting component 250 can log that chunks 212 is to be deleted and that chunk 232 is to be reduced correspondingly. Generation of chunk 213 can be delayed until a threshold time has passed or a threshold condition has occurred. As an example, deletion can be deferred until utilization of system 200 computing resources is below a threshold level, for example deferring deletion until use of system 200 is slow, perhaps late at night, etc. Upon the satisfaction of the threshold time/condition, deleting component 250 can facilitate generating of chunk 213, reduction of chunk 232 to chunk 233, and subsequent deletion of chunks 212, 213, and 232.

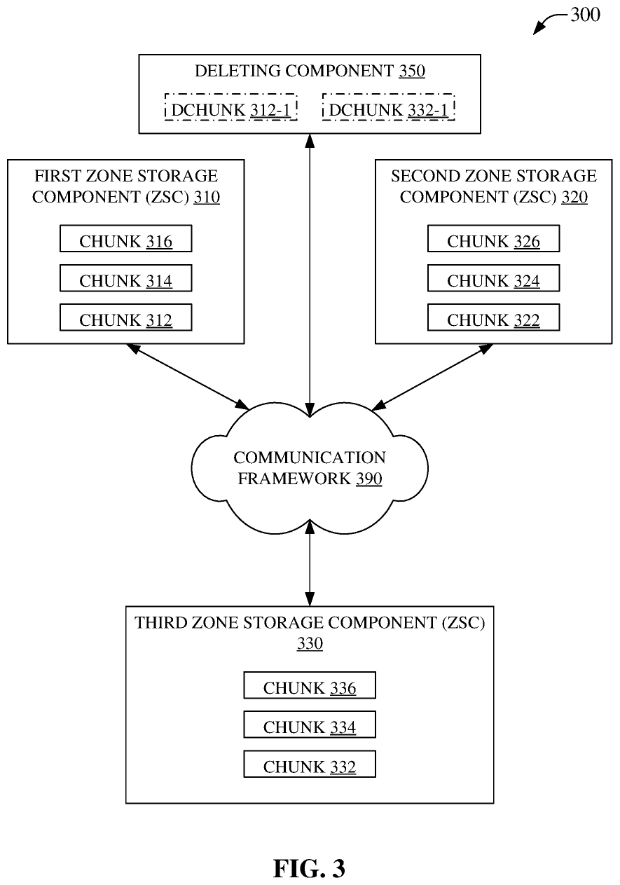

FIG. 3 is an illustration of a system 300, which can facilitate deferred reduction of convolution of a convolved chunk in accord with log-based management of storage space for geographically diverse storage, in accordance with aspects of the subject disclosure. System 300 can be the same as, or similar to system 200, and can comprise ZSCs 310, 320, 330, etc., communicating via communication framework 390, wherein chunks 312-316 can be stored at first ZSC 310, chunks 322-326 can be stored via second ZSC 320, and chunks 332-336 can be stored by third ZSC 330. As illustrated in system 300, deleting component 350 can log chunks relevant to a deletion operation. As an example, deleting component can log dchunk 312-1 that can indicate chunk 312 is to be deleted, can log dchunk 332-1 that can indicate chunk 332 is to be reduced, etc. The representation of dchunks having perforated boarders is meant to indicate that these are not actual chunks stored at deleting component 350, but are rather information indicating that the corresponding chunks are part of a deferred deletion operation, e.g., the dchunks can be log entries, table entries, list entries, data base entries, flags, or nearly any other indicator that the related chunk is to be delete, reduced, etc. In an aspect, a dchunk can indicate the composition of a chunk, e.g., where a chunk is a convolution of chunks A, B, C, and D, then the dchunk can indicate this aspect such that, for example, upon chunk A being marked for deletion, the dchunk can enable determining that after deconvolution a reduced convolved chunk would comprise information redundant to B, C, and D. This information can therefore facilitate deconvolving, e.g., (ABCD XOR A)=(BCD). Further, this information can facilitate determining that ABCD can be deleted where B, C, and D can be replicated to preserve the data protection, e.g., B, C, and D can be copied rather than copying A and performing deconvolution. In an aspect, B, D, and D can then be convolved as appropriate, e.g., as (B), (C), and (D); as (BCD); as (BC) and (D); as (B) and (CD), etc.

In an embodiment of system 300, where the deferral is expired, the dchunks, e.g., dchunk 312-1, 332-1, etc., can be employed in undertaking the deletion operation. In an aspect, this can comprise generating another chunk that represents the information of chunk 332 sans the information represented by chunk 312, after which chunks 332 and 312 can be deleted, freed, etc., and dchunks 312-1 and 332-1 can be removed from deleting component 350. As a first example, chunk 312 can be copied to third ZSC 330 and chunk 332 can be deconvolved accordingly. As another example, chunk 322 can be copied to third ZSC 330 rather than deconvolving chunk 332, e.g., where chunk 332 is 312 XOR 322, then 332 XOR 312 is 322 and, as such, it can be more computing resource efficient to simply copy 322 to ZSC 330 rather than copying 312 and performing the deconvolution, as will be illustrated in more detail elsewhere herein.

FIG. 4 is an illustration of a system 400, which can enable log-based management of storage space for geographically diverse storage employing distributed deleting component(s), in accordance with aspects of the subject disclosure. System 400 can comprise ZSCs, e.g., 410-440, etc., communicating via communication framework 490. In an aspect, deleting components can be distributed among the ZSCs, e.g., deleting component 452-458. In an aspect, a deleting component can be hardware and/or software, e.g., deleting component 452 can be a discrete component of first ZSC 410, deleting component 454 can be an instance of a virtual deleting component executing on a processor of second ZSC 420, etc. In an aspect, deleting components 452-458 can act as components of a single distributed deleting component. In another aspect, deleting components 452-458 can act as separate deleting components. In some embodiments, the deleting components 452-458 can be a mix of independent deleting components and a distributed deleting component, e.g., each deleting component 452-458 can be an independent deleting component that can also contribute to a single distributed deleting component instance. In some embodiments, a separate deleting component, such as illustrated in system 100-300, etc., can also be comprised in system 400 although not illustrated for clarity and brevity.

Similar to system 300, in system 400, deleting components can log chunks participating in a deferred deletion operation, e.g., as dchunks. Accordingly, for example, where chunk 412 is to be deleted, deleting component 452 can log dchunk 412-1. This can be communicated to other deleting comps, e.g., 454-458, which can determine if any chunks in the corresponding zones are related to the deletion of chunk 412. As an example, where chunk 442 convolves information of chunk 412, e.g., chunk 442=412 XOR 422 XOR 432, etc., then deleting component 458 can log dchunk 442-1. Accordingly, upon satisfaction of the deferral, generating another chunk that represents the information of chunk 442 sans the information represented by chunk 412, after which chunks 442 and 412 can be deleted and dchunks 412-1 and 442-1 can be removed from deleting components 452 and 458 correspondingly. As an example, where 442=412 XOR 422 XOR 432, then 412 can be copied to ZSC 440 to allow deconvolution of 442, e.g., 442 XOR Replicate of 412=(412 XOR 422 XOR 432) XOR Replicate of 412=(422 XOR 432). Alternatively, each of chunks 422 and 432 can be copied to fourth ZSC 440 and chunk 442 can just be deleted without deconvolution. In an aspect, each of chunks 422 and 432 can be copied to any ZSC that can provide data protection to chunks 432 and 422 in system 400, e.g., copying is not limited to creating a replicate in ZSC 440 unless that is the only ZSC that can provide data protection to chunks 422 and/or 432 in system 400, and chunk 442 can just be deleted without deconvolution. As an example, chunk 422 can be copied into first ZSC 410 and chunk 432 can be copied into second ZSC 420 and can still provide data protection through redundancy on system 400.

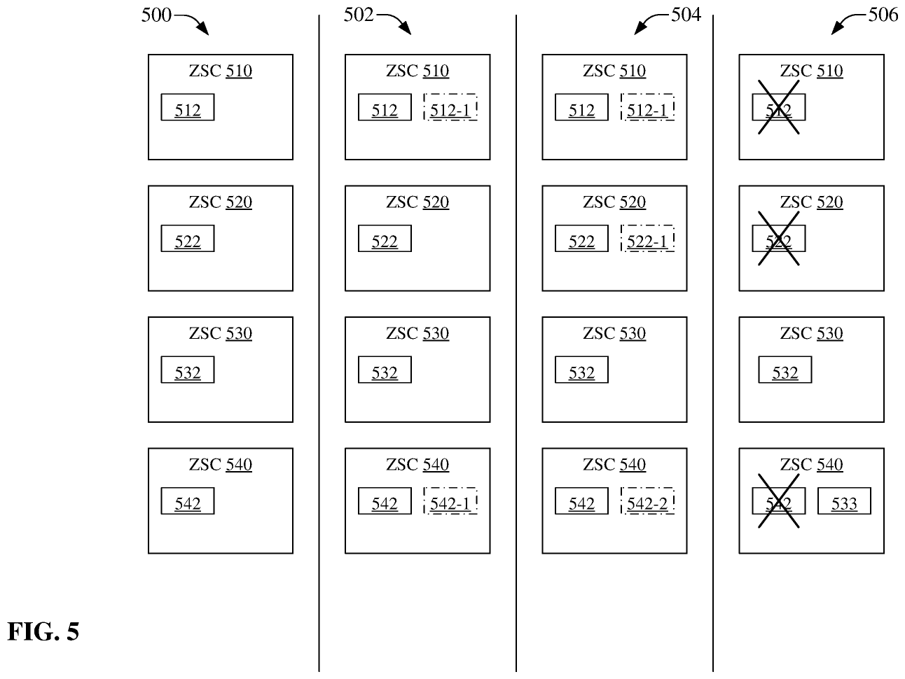

FIG. 5 is an illustration of example system states, 500-506, log-based management of storage space for geographically diverse storage, wherein the log-based management comprises replication of a portion of information comprised in a convolved chunk, in accordance with aspects of the subject disclosure. Example first state 500 illustrates ZSCs 510-540 correspondingly comprising data chunks 512-542. As an example, data chunk 542 can be an XOR of chunks 512-532, etc., to aid in understanding of the disclosed subject matter. It is to be noted that the ZSCs 510-540 can, in fact, comprise other stored chunks without departing from the scope of the instant disclosure, but are omitted to avoid introducing confusion.

At example system state 502, a chunk can be determined as ready to be deleted. As an example, it can be determined that chunk 512 can be deleted. As is noted elsewhere herein, simply deleting chunk 512 can compromise the integrity of chunk 542 with regard to recovery of backup data for chunks 522 and 532 of the preceding example. The integrity can be compromised because without chunk 512, e.g., if chunk 512 is simply deleted, deconvolution of chunk 542 to recover data for chunk 522, 532, etc., can be frustrated. As an example, where 542=512⊕522⊕532, then 522 can be recovered based on 542⊕512⊕532=522, however, where 512 has been deleted, this deconvolution can be frustrated and 522 can be unrecoverable from 542. A similar explanation is apparent for recovery of 532 in the absence of 512. Accordingly, it can be desirable to reduce the convolution of 542 before deleting 512, e.g., 542⊕512=(512⊕522⊕532)⊕512=(522⊕532) which can retain integrity to recover either 522 and/or 532 without 512. As such, at 502, both 512 and 542 can be marked as being related to deletion, e.g., dchunk 512-1 and dchunk 542-1 can be generated and can be similar to, or the same as, dchunks 312-1, 332-1, 412-1, 442-1, etc., in FIGS. 3 and 4.

The example system can defer deletion of chunk 512 as is also disclosed elsewhere herein. In an aspect, the system can retain the dchunks, e.g., dchunks 512-1 and 542-1, through additional system states. As an example, additional chunks can be stored by the example system between system state 502 and 504, though these are not illustrated for clarity and brevity. In an aspect, this can facilitate deferred deletion of chunk 512 while enabling continued use of the example system for geographically diverse storage and protection of stored data. In FIG. 5, for example, additional chunks can become available for deletion.

At example state 504, chunk 522 can be determined as available for deletion. For reasons that can be the same as, or similar to, the readiness of chunk 512 to be deleted, chunk 542 can again be addressed to avoid impairing the protection of chunk 532. As such, dchunk 522-1 can be generated. Similarly, dchunk 542-2 can be generated. In an aspect, dchunk 542-2 can indicate that information of both chunks 512 and 522 should be removed from chunk 542 to reduce the convolution of chunk 542 to facilitate retaining the protection of chunk 532. It is noted that at state 504, none of chunks 512, 512-1, 522, 522-1, etc., have been deleted, nor has chunk 542 actually been reduced. Again, as at state 502, deletion of chunk 512, and now 522, can be deferred.

The example system can reach a point where the deferral ends and deletion of chunks 512 and 522 should occur, for example, a condition has been met, a time threshold has been transitioned, etc. As such, at state 506, the example system can determine that applying dchunk 542-2, which indicates reducing the convolution of 542 to exclude 512 and 522, should occur. Whereas 542 convolves, in this example, three other chunks, e.g., 512-532, the reduction by two of the three chunks can comprise replicating the two chunks and then performing corresponding deconvolving operations. This can be more computing resource intensive than replicating the one remaining chunk convolved into chunk 542, e.g., where removing chunks 512 and 522 from chunk 542 results in chunk 542=532, it can be less computer resource intensive to simply replicate chunk 532, as chunk 533 in ZSC 540, than to actually replicate chunks 512 and 522 and then perform the deconvolution, yet arrives at the same result.

Accordingly, at example state 506, chunk 532 can be replicated to ZSC 540 based on dchunk 542-2 and chunk 542. This serves to protect chunk 532 at ZSC 530. Subsequent to generating chunk 533, chunk 542 can be deleted because the protection of chunk 532 is now performed via chunk 533. Additionally, chunks 512 and 522 can be deleted as they are no longer needed to maintain the integrity of chunk 542. Similarly, dchunks 512-1, 522-1, and 542-2 can be removed. As a result, system state 506 can comprise chunk 532 in ZSC 530 and chunk 533 in ZSC 540, where chunk 533 is a backup of the data of chunk 532. It is noted that chunk 533 could have been generated in any of the ZSCs other than ZSC 530 to provide geographically diverse redundancy to chunk 532 and all such permutations are considered within the scope of the instant disclosure despite not being further discussed for the sake of clarity and brevity. It is further noted that rather than replicating chunk 532 as chunk 533, the example system can in fact replicate chunks 512 and 522 to perform the reduction in the convolution of chunk 542 without departing from the scope of the instant disclosure, although not being further discussed for the sake of clarity and brevity.

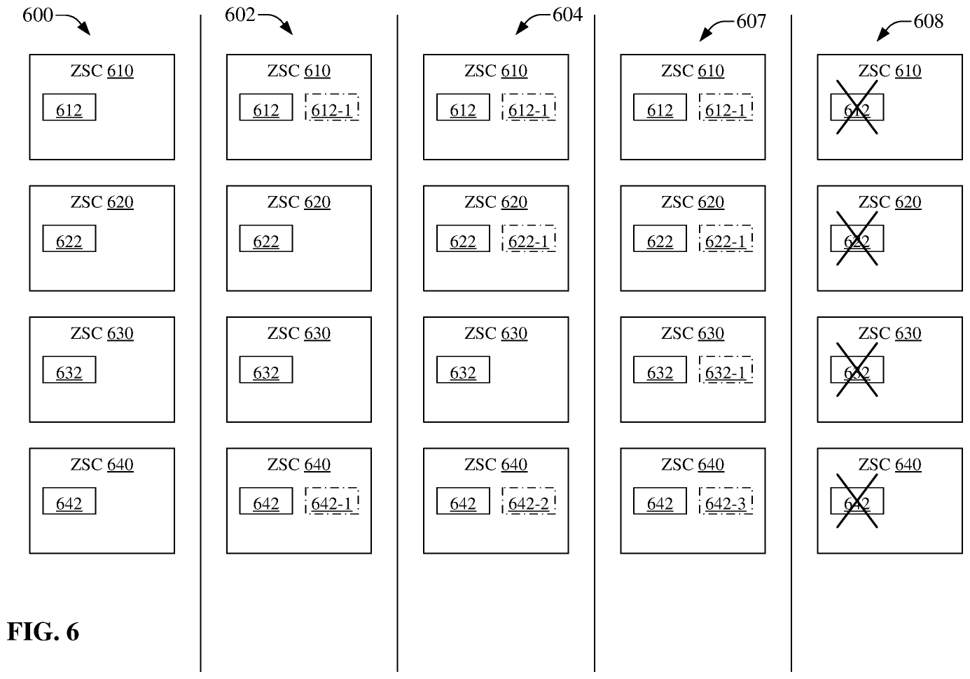

FIG. 6 is an illustration of example system states, 600-608, for log-based management of storage space for geographically diverse storage, wherein the log-based management avoids replication of a portion of information comprised in a convolved chunk, in accordance with aspects of the subject disclosure. Example first state 600 illustrates ZSCs 610-640 correspondingly comprising data chunks 612-642. As an example, data chunk 642 can be an XOR of chunks 612-632, etc., to aid in understanding of the disclosed subject matter. It is again noted that the ZSCs 610-640 can comprise other chunks without departing from the scope of the instant disclosure.

At example system state 602, a chunk can be determined as ready to be deleted. As an example, it can be determined that chunk 612 can be deleted. As is noted elsewhere herein, simply deleting chunk 612 can compromise the integrity of chunk 642 with regard to recovery of backup data for chunks 622 and 632. The integrity can be compromised because without chunk 612, e.g., if chunk 612 is simply deleted, deconvolution of chunk 642 to recover data for chunk 622, 632, etc., can be frustrated. As such, at 602, both 612 and 642 can be marked as being related to a deletion operation, e.g., dchunk 612-1 and dchunk 642-1 can be generated and can be similar to, or the same as, dchunks 312-1, 332-1, 412-1, 442-1, 512-1, 522-1, 542-1, 542-2, etc., in the preceding FIGs. The example system of FIG. 6 can defer deletion of chunk 612, as is disclosed elsewhere herein.

At example state 604, chunk 622 can be determined as being available for deletion. As such, dchunk 622-1 can be generated. For reasons that can be the same as, or similar to, the readiness of chunk 612 for deletion, chunk 642 can again be addressed to avoid impairing the protection of chunk 632. Accordingly, dchunk 642-2 can be generated and can indicate that information of both chunks 612 and 622 should be removed from chunk 642 to reduce the convolution of chunk 642 in a manner that facilitates continuing protection of chunk 632. Again, as at state 602, deletion of chunk 612, and now 622, can be deferred.

At example state 607, chunk 632 can be determined as being available for deletion. As such, dchunk 632-1 can be generated. For reasons that can be the same as, or similar to, the readiness of chunks 612, 622, etc., for deletion, chunk 642 can again be addressed, e.g., where chunk 642 can convolve other non-illustrated chunks, modification of chunk 642 to maintain the integrity of protecting these other chunks can be desirable. Accordingly, dchunk 642-3 can be generated and can indicate that information of chunks 612, 622, and 632 should be removed from chunk 642 to reduce the convolution of chunk 642 in a manner that facilitates continuing protection of any other non-illustrated chunk(s). Again, as at state 602, deletion of chunk 612, and now 622, can be deferred.

In an aspect, where 642 can be later modified by additional chunk convolution, dchunk 643-3 can remain valid and can enable the example system to properly reduce the convolution of chunk 642 to maintain protection. As an example, at 607, 642=(612⊕622⊕632) where chunks 612, 622, and 632 are to be deleted, e.g., as indicated by dchunks 612-1, 622-1, 632-1, and 642-3. In this example, as an aside, at a non-illustrated state between 607 and 608, chunk Y can be protected via convolution of replicate data into chunk 642 such that 642′=(612⊕622⊕632⊕Y). In this situation dchunk 642-3 can still provide information enabling the proper reduction of the convolution of 642′ to remove 612-632, e.g., to maintain protection of chunk Y, etc. This aside is not further discussed for the sake of clarity and brevity although all aspects of this aside are considered within the scope of the instant disclosure.

The system, at example state 607, can reach a point where the deletion of chunks 612, 622, and 632 should occur, e.g., deferral ends, for example, a condition has been met, a time threshold has been transitioned, etc. As such, at state 607, the example system can determine that applying dchunk 642-3 should occur, which can indicate information enabling the reduction of the convolution of 642 to exclude 612, 622, and 632. Whereas 642=(612⊕622⊕632), e.g., chunk 642 convolves chunks 612-632, the reduction of 642 by removing all chunks can comprise copying each of chunks 612-632 and then performing corresponding deconvolution. This process can be important where, for example, chunk 642 can have undergone further convolution to convolve other chunks, such as chunk Y noted herein above. However, where the reduction of 642 removes all convolved chunks, it can be understood that this can be the same as simply deleting chunk 642 without any replication of chunks 612-632 and without consuming computing resources to perform any corresponding deconvolutions. As such, at example state 608, chunk 642 can be deleted without replication of any portion of information comprised in a convolved chunk. Similarly, chunks 612, 622, and 632 can be deleted. Additionally, dchunks 612-1, 622-1, 632-1, and 642-3 can be removed. It is noted that rather than deleting 642, the example system can in fact replicate chunks 612-632 to perform the reduction in the convolution of chunk 642 without departing from the scope of the instant disclosure, although not being further discussed for the sake of clarity and brevity.

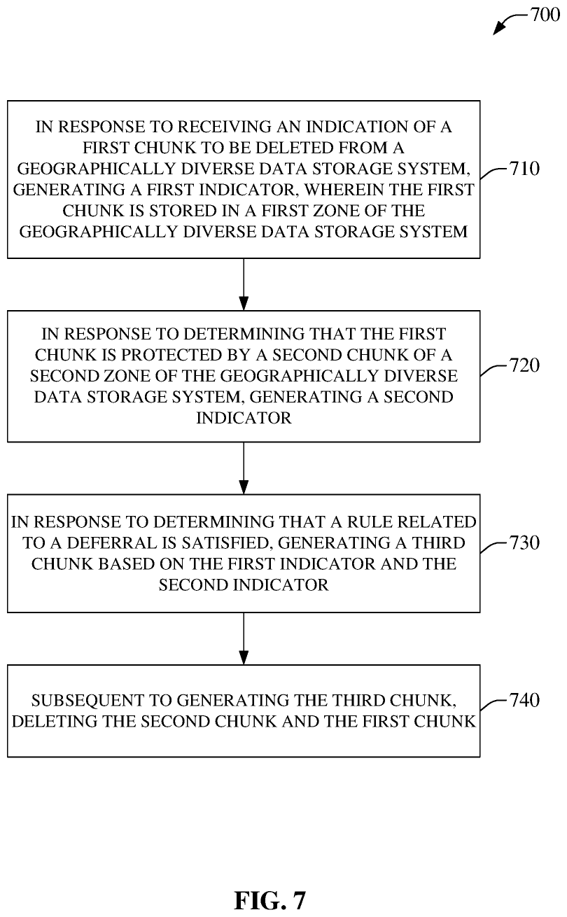

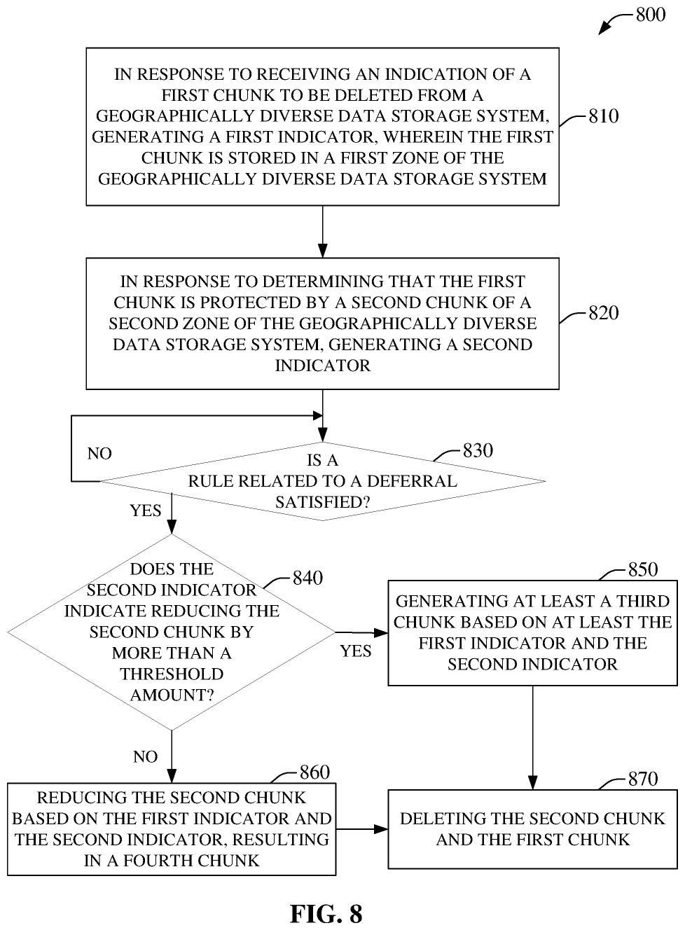

In view of the example system(s) described above, example method(s) that can be implemented in accordance with the disclosed subject matter can be better appreciated with reference to flowcharts in FIG. 7-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 7 is an illustration of an example method 700, which can facilitate log-based management of storage space for geographically diverse storage, in accordance with aspects of the subject disclosure. At 710, method 700 can comprise generating a first indicator in response to receiving an indication of a first chunk to be deleted from a first zone of a geographically diverse data storage system. In an aspect, the first chunk can be stored in the first zone and can be protected by data stored in a second chunk stored at a second zone of the geographically diverse data storage system. In an embodiment, the second chunk can be a convolved chunk that can convolve a representation of the first chunk and representation(s) of other chunk(s). As an example, second chunk =(first chunk XOR other chunk(s)). Accordingly, if the first chunk becomes less available, data represented in the first chunk can be recovered from the second chunk, for example, by deconvolving the second chunk with the other chunk(s) to yield a replica of the data stored in the now less accessible first chunk. As an example, B=(A XOR C) such that where A is less accessible, (B XOR C)→replica of A. In an aspect, the first indicator can be a dchunk, as disclosed elsewhere herein, and can indicate that the first chunk is ‘available to be deleted’.

At 720, method 700 can comprise generating second indicator in response to determining that the first chunk is protected by a second chunk of a second zone of the geographically diverse data storage system. In an aspect, the second indicator can be a dchunk, again as disclosed elsewhere herein, and can indicate that the second chunk ‘comprises a representation of a chunk that is available to be deleted’. In an aspect, the second chunk can be a convolved chunk that can convolve a representation of data of the first chunk and representation(s) of data of other chunk(s), such as illustrated in the preceding example.

Method 700, at 730, can comprise generating third chunk in response to determining that a rule related to a deferral is satisfied. The rule related to the deferral can be satisfied, for example, by an elapsed time, a condition of a zone of the geographically diverse data storage system transitioning a threshold level, a computing resource utilization rate, etc. As an example, the deferral rule can be satisfied by the first zone reaching a threshold level of occupied storage space, e.g., where the first zone is running low on available storage space it can be more urgent to delete garbage chunks and therefore the rule can be satisfied so that the deletion of the first chunk is no longer deferred.

In an aspect, the third chunk can be based on the first indicator and the second indicator. Whereas the first indicator can indicate a chunk to be deleted, e.g., the first chunk, and the second indicator can indicate a modification of another chunk, e.g., modification of the second chunk, the third chunk can reflect the modification of the second chunk. As an example, if the second chunk convolves the first chunk and another chunk, then the second indicator can indicate that the first chunk is available to be deconvolved from the second chunk, thereby reducing the convolution of the second chunk to a chunk only protecting the other chunk. As such, it can be determined that it is less taxing on computing resources to merely generate a copy of the other chunk as the third chunk rather than replicating the first chunk and also deconvolving the second chunk to generate a third chunk. As a second example, if the second chunk convolves the first chunk and three other chunks, then the second indicator can indicate that the first chunk is available to be deconvolved from the second chunk, thereby reducing the convolution of the second chunk to a chunk only protecting the three other chunks. As such, it can be determined that it is less taxing on computing resources to replicate the first chunk and deconvolving the second chunk to generate a third chunk protecting the three other chunks rather than generating replicates of the three other chunks.

At 740, method 700 can comprise deleting the first and second chunks subsequent to generating the third chunk. At this point method 700 can end. In an embodiment the third chunk can be a reduction of the second chunk. In an embodiment the third chunk can be at least a replicate of another chunk. In an aspect, the third chunk can provide protection to chunks protected by the second chunk other than the chunks to be deleted, e.g., the first chunk, etc., as can be indicated by the first indicator and the second indicator. Accordingly, once the other chunks are protected via at least the third chunk, the first chunk and the second chunk can be deleted.

FIG. 8 is an illustration of an example method 800, which can enable log-based management of storage space for geographically diverse storage, wherein the log-based management comprises reducing a convolved chunk or generating a new chunk to provide data protection, in accordance with aspects of the subject disclosure. At 810, method 800 can comprise generating a first indicator in response to receiving an indication of a first chunk to be deleted from a first zone of a geographically diverse data storage system. In an aspect, the first chunk can be stored in the first zone and can be protected by data stored in a second chunk stored at a second zone of the geographically diverse data storage system. In an embodiment, the second chunk can be a convolved chunk that can convolve a representation of the first chunk and representation(s) of other chunk(s). As an example, second chunk=(first chunk XOR other chunk(s)). Accordingly, if the first chunk becomes less available, data represented in the first chunk can be recovered from the second chunk, for example, by deconvolving the second chunk with the other chunk(s) to yield a replica of the data stored in the now less accessible first chunk. As an example, B=(A XOR C) such that where A is less accessible, (B XOR C)→replica of A. In an aspect, the first indicator can be a dchunk, as disclosed elsewhere herein, and can indicate that the first chunk is ‘available to be deleted’.

At 820, method 800 can comprise generating second indicator in response to determining that the first chunk is protected by a second chunk of a second zone of the geographically diverse data storage system. In an aspect, the second indicator can be a dchunk, again as disclosed elsewhere herein, and can indicate that the second chunk ‘comprises a representation of a chunk that is available to be deleted’. In an aspect, the second chunk can be a convolved chunk that can convolve a representation of data of the first chunk and representation(s) of data of other chunk(s), such as illustrated in the preceding example.

Method 800, at 830, can comprise determining if a rule related to a deferral is satisfied. The rule related to the deferral can be satisfied, for example, by an elapsed time, a condition of a zone of the geographically diverse data storage system transitioning a threshold level, a computing resource utilization rate, etc. As an example, the deferral rule can be satisfied by the first zone reaching a threshold level of occupied storage space, e.g., where the first zone is running low on available storage space it can be more urgent to delete garbage chunks and therefore the rule can be satisfied so that the deletion of the first chunk is no longer deferred. Where the rule is satisfied, method 800 can advance to 840. However, where the rule is not satisfied, method 800 can again check to see if the rule is satisfied. In an aspect, this enables method 800 to wait until the rule is satisfied before proceeding.

At 840, method 800 can comprise determining if the second indicator indicates reducing the second chunk by a threshold amount. In an embodiment, the threshold amount can be, for example, half, e.g., if the second chunk convolves two other chunks and the second indicator indicates a that one chunk will be deconvolved from the second chunk then, in this example, the threshold level of half can be achieved. Similarly, in another example, if the second chunk convolves five other chunks then deconvolving the first chunk from the second chunk can reduce the second chunk convolution by ⅕th, which can be less than the example threshold of half.

At 850, where the reduction of the second chunk traverses the threshold amount, then at least a third chunk can be generated based on at least the first indicator and the second indicator. In an aspect, traversing the reduction threshold at 840 can indicate that a count of chunks to be deleted can be sufficiently high that it can consume less computing resources to replicate chunks that are not to be deleted to provide protection for those chunks that it would be to replicate the chunks to be deleted and then perform the deconvolution to reduce the second chunk convolution level. As an example, where the second chunk convolves ten total chunks, and where the second indicator indicates that nine of the ten chunks are to be deconvolved, then it can represent a computing resource savings to replicate the tenth chunk that is not to be deleted rather than to replicate the first to ninth chunks that are to be deleted and then perform the corresponding deconvolution operations to arrive at a reduced chunk that represents the same information as the replicate of the tenth chunk. Method 800 can proceed from block 850 to block 870 as disclosed herein below.

At 860, where the reduction of the second chunk does not traverses the threshold amount, then at least a fourth chunk can be generated based reducing the second chunk convolution according to the at least the first indicator and the second indicator. In contrast to method 800 at block 850, method 800 at block 860 can realize conservation of computing resources by replicating to be deleted chunks and performing corresponding deconvolution on the second chunk rather than replicating chunks that are not to be deleted. As an example, where the second chunk convolves ten total chunks, and where the second indicator indicates that one of the ten chunks is to be deconvolved, then it can represent a computing resource savings to replicate the first chunk that is to be deleted and perform the deconvolution, resulting in the fourth chunk comprising a convolution of the second to tenth chunks, rather than to replicate the second to tenth chunks that are not to be deleted. Method 800 can proceed from block 860 to block 870 as disclosed herein below.

At 870, method 800 can comprise deleting the second chunk and the first chunk. At this point method 800 can end. In an aspect, the first and second indicators can also be removed as they can be irrelevant to the stored data after the corresponding chunks have been deleted. As an example, where the second indicator is dblock 642-1 of FIG. 6, then where block 612 is deleted and protection is provided for block 622 and 632 via block 850 or 860, then dblock 642-1 can be removed. It is however noted that where the second indicator comprises additional deletion operation information, e.g., relevant to other deletions to be performed, the second indicator can be retained, modified, etc. As an example, where the second indicator is dblock 642-2 of FIG. 6, then where block 612 is deleted and protection is provided for block 632 via block 850 or 860 but block 622 is not yet deleted, then dblock 642-2 can be retained, e.g., until chunk 622 is deleted and the protection of block 632 is preserved.

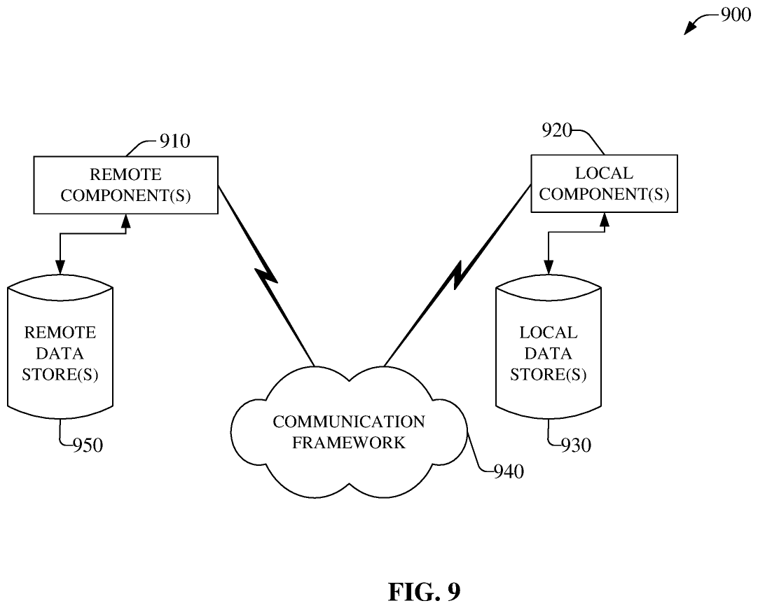

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a remotely located ZSC connected to a local ZSC via communication framework 940. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise a local ZSC connected to a remote ZSC via communication framework 190, 290, 390, 490, 940, etc. In an aspect the remotely located ZSC or local ZSC can be embodied in ZSC 110-130, ZSC 210-230, ZSC 310-330, ZSC 410-440, ZSC 510-540, ZSC 610-640, etc., deleting component 150, 250, 350, 452, 454, 456, 458, etc., or other components.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940. As examples, information corresponding to chunks stored on ZSCs can be communicated via communication framework 190,-490, 940, etc., to other ZSCs of a storage network, e.g., to facilitate storage, convolution, reduction, etc., as disclosed herein.

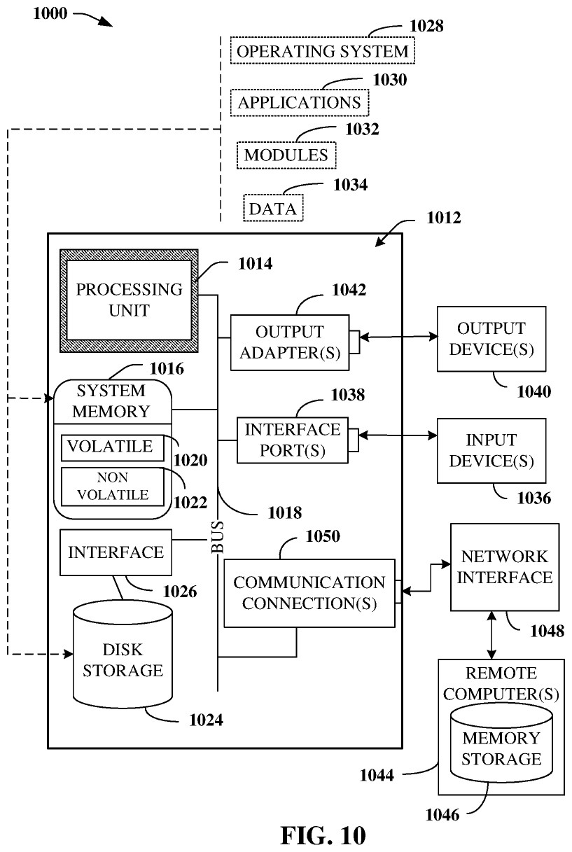

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory , dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in a ZSC, e.g., 110-130, 210-230, 310-330, 410-440, 510-540, 610-640, etc., deleting component 150-350, 452-458, etc., or other components, can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations, comprising determining that a first chunk is to be deleted, wherein the first chunk is related to a second chunk via the second chunk convolving information represented in the first chunk and at least a third chunk, and wherein the second chunk provides redundancy for the first chunk and redundancy for at least the third chunk. The operations can further comprise, for example, logging a first and second record correspondingly indicating the first chunk is available to be deleted and that the second chunk convolves information of the to be deleted first chunk with information of at least the third chunk. Then, in response to determining that a deferral condition is satisfied, a fourth chunk that redundantly protects at least the third chunk can be generated before the first chunk and the second chunk are deleted, as is disclosed elsewhere herein.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
in response to determining that a first chunk is to be deleted from a first zone storage component of a geographically distributed storage system, logging an indicator corresponding to the first chunk;
in response to determining that a second chunk convolves first information represented in the first chunk, logging a second indicator corresponding to the second chunk, wherein the second chunk is stored via a second zone storage component of the geographically distributed storage system, and wherein the second chunk provides redundancy of the data of the first chunk; and
in response to generating a third data chunk based on at least the first indicator and the second indicator, wherein the third chunk represents other information of chunks convolved in the second chunk and excludes representation of the first information of the first chunk, deleting the first chunk and the second chunk.

2. The system of claim 1, wherein the generating the third data chunk is deferred until a condition of the geographically distributed storage system is determined to satisfy a rule related to triggering deletion of the first chunk.

3. The system of claim 2, wherein the rule relates to a threshold count of other chunks to be deleted being logged in the geographically distributed storage system.

4. The system of claim 3, wherein the second chunk convolves other information represented in the other chunks to be deleted.

5. The system of claim 2, wherein the rule is a temporal rule relating to a selectable elapsed time after the determining that the first chunk is to be deleted.

6. The system of claim 2, wherein the rule is a computing resource rule relating to a selectable processor availability threshold.

7. The system of claim 2, wherein the rule is a computing resource rule relating to a selectable remaining storage threshold of the first zone storage component.

8. The system of claim 2, wherein the rule is a computing resource rule relating to a selectable remaining storage threshold of the second zone storage component.

9. The system of claim 1, wherein the generating the third chunk comprises reducing a level of convolution of the second chunk based on the second chunk, the first chunk, the second indicator, and the first indicator.

10. The system of claim 1, wherein the second chunk comprises convolution of information of the first chunk and information of a fourth chunk, wherein the fourth chunk is stored via a third zone storage component of the geographically distributed storage system.

11. The system of claim 10, wherein the generating the third chunk comprises replicating the fourth chunk.

12. The system of claim 10, wherein the generating the third chunk does not comprise replicating the first chunk and does not comprise deconvolution of the second chunk based on the first chunk.

13. A method, comprising:
determining, by a system comprising a processor, that a first chunk is to be deleted from a first zone storage component of a geographically distributed storage system;
determining, by the system, that a second chunk convolves information represented in the first chunk and at least a third chunk, wherein the second chunk is stored via a second zone storage component of the geographically distributed storage system, wherein at least the third chunk is stored via at least a third zone storage component of the geographically distributed storage system, and wherein the second chunk provides redundancy for the first chunk and redundancy for at least the third chunk;
generating, by the system, a first record indicating the first chunk is available to be deleted and a second record indicating that the second chunk convolves information of the first chunk that is available to be deleted with information of the third chunk;
in response to determining, by the system, that a deferral condition is satisfied, determining a fourth chunk based on at least the first record and the second record; and
deleting, by the system, the first chunk and the second chunk.

14. The method of claim 11, wherein the determining that the deferral condition is satisfied comprises determining that a parameter of the geographically distributed storage system has transitioned a selectable threshold value.

15. The method of claim 11, wherein the determining the fourth chunk comprises replicating the first chunk and deconvolving the second chunk based on the replicate of the first chunk.

16. The method of claim 11, wherein the determining the fourth chunk comprises replicating at least the third chunk but does not comprise deconvolving the second chunk based on a replicate of the first chunk.

17. The method of claim 11, wherein the determining the fourth chunk comprises determining a null chunk.

18. A machine-readable storage medium, comprising executable instructions that, when executed by a processor, facilitate performance of operations, comprising:
determining that a first chunk is to be deleted from a first zone storage component of a geographically distributed storage system, wherein the first chunk is related to a second chunk via the second chunk convolving information represented in the first chunk and at least a third chunk, wherein the second chunk is stored via a second zone storage component of the geographically distributed storage system, wherein at least the third chunk is stored via at least a third zone storage component of the geographically distributed storage system, and wherein the second chunk provides redundancy for the first chunk and redundancy for at least the third chunk;
logging a first record indicating the first chunk is available to be deleted and a second record indicating that the second chunk convolves information of the first chunk with information of at least the third chunk and that the first chunk is available to be deleted;
in response to determining that a deferral condition is satisfied, generating a fourth chunk that redundantly protects at least the third chunk and is based on the first record and the second record; and
deleting the first chunk and the second chunk.

19. The machine-readable storage medium of claim 18, wherein the deferral condition is satisfied by a parameter of the geographically distributed storage system transitioning a selectable threshold value.

20. The machine-readable storage medium of claim 18, wherein:
the determining the fourth chunk comprises replicating the first chunk and deconvolving the second chunk based on the replicate of the first chunk, or
the determining the fourth chunk comprises replicating at least the third chunk but does not comprise deconvolving the second chunk based on a replicate of the first chunk.
